(19) United States
(12) Patent Application Publication
(10) Pub. No.: US 2025/0378081 A1
(43) Pub. Date: Dec. 11, 2025

(54) TECHNIQUES FOR PROVIDING RELEVANT RESULTS FOR QUERIES

(71) Applicant: Apple Inc., Cupertino, CA (US)

(72) Inventors: Kun DUAN, Mountain View, CA (US); Atsuhito KITA, Seattle, WA (US); Kevin W. LEE, San Jose, CA (US); Lei CHEN, Campbell, CA (US); Shuangning LIU, San Francisco, CA (US); Xinyu LIU, Seattle, WA (US); Yantao ZHENG, Cupertino, CA (US); Yi WU, San Jose, CA (US)

(21) Appl. No.: 19/201,453

(22) Filed: May 7, 2025

Related U.S. Application Data
(60) Provisional application No. 63/657,851, filed on Jun. 8, 2024.

(51) Int. Cl. G06F 16/2457

(52) U.S. Cl. CPC G06F 16/24578

(57) ABSTRACT

Disclosed are techniques for providing relevant results for queries. A method can be implemented by a server computing device, and includes (1) receiving a query from a client computing device, (2) providing the query to a first machine learning (ML) model to produce a text answer to the query, (3) providing, to a second ML model, (i) the query, and (ii) the text answer, to obtain one or more digital assets that correspond to the query and the text answer, (4) generating results based on (i) the query, (ii) the text answer, and (iii) the one or more digital assets, and (5) causing the results to be output by way of a user interface on the client computing device. Other embodiments include generating text answers that include a plurality of text segments, where at least one image is obtained for each text segment of the plurality of text segments.

### CROSS-REFERENCE TO RELATED APPLICATIONS

The present application claims priority to U.S. Provisional Patent Application Ser. No. 63/657,851, entitled “TECHNIQUES FOR PROVIDING RELEVANT RESULTS FOR QUERIES” filed Jun. 8, 2024, which is hereby incorporated by reference in its entirety for all purposes.

### FIELD

The described embodiments relate generally to providing relevant results for queries. More particularly, the described embodiments provide techniques for identifying digital assets—such as digital images, animations, videos, etc.—that are relevant to text-based results generated in response to a given query, and then organically incorporating the digital assets into the text-based results.

### BACKGROUND

Obtaining digital assets—such as digital images—that are relevant to text-based results presents several inherent difficulties. First, the challenge of semantic understanding is significant. In particular, text-based queries often rely on nuanced language, idiomatic expressions, and contextual meaning that can be difficult for algorithms to accurately interpret. For instance, a search for “java” could represent a user looking for information about the island of Java in Indonesia, Java coffee, or the programming language Java®. Search algorithms must be able to discern these contexts from the accompanying text to obtain appropriate digital images.

Another layer of complexity is introduced by the variability in users' intent. In particular, different users may use the same keywords, but expect different types of digital images to be shown based on their unique contexts or needs. This variability necessitates a system that can adapt and personalize search results in an effective manner. Furthermore, the quality and relevance of the digital images found must be high to meet users' expectations. This involves matching the content of the digital images to the text-based results, as well as ensuring that the digital images are visually appealing and relevant.

It is also challenging to incorporate digital images into text-based results. In particular, the integration should feel seamless and enhance users' experiences, rather than disrupt them. To achieve this end, the digital images should provide visual support to the text-based results without overshadowing it. There also should be an appropriate balance between the text-based results and the digital images, which requires careful consideration of digital image placement, size, and relevance to the surrounding text. For example, it is desirable to place digital images next to their most relevant text sections, as thumbnails that can be expanded for more detail, and so on.

Additionally, there is the technical challenge of indexing digital images so they can be efficiently identified and retrieved. In particular, images should be stored, categorized, and indexed in a way that allows for efficient retrieval and accurate assignment to text-based results. This can help ensure that the digital images load quickly and do not negatively impact performance when providing the results, thereby improving the overall user experience.

Accordingly, what is needed is an improved technique for identifying digital assets—such as digital images, animations, videos, etc.—that are relevant to text-based results generated in response to a given query, and then organically incorporating the digital assets into the text-based results.

### SUMMARY

The described embodiments relate generally to providing relevant results for queries. More particularly, the described embodiments provide techniques for identifying digital assets—such as digital images, animations, videos, etc.—that are relevant to text-based results generated in response to a given query, and then organically incorporating the digital assets into the text-based results.

One embodiment sets forth a method for providing relevant results for queries. According to some embodiments, the method can be implemented by a server computing device, and includes the steps of (1) receiving a query from a client computing device, (2) providing the query to a first machine learning (ML) model to produce a text answer to the query, (3) providing, to a second ML model, (i) the query, and (ii) the text answer, to obtain one or more digital assets that correspond to the query and the text answer, (4) generating results based on (i) the query, (ii) the text answer, and (iii) the one or more digital assets, and (5) causing the results to be output by way of a user interface on the client computing device.

Another embodiment sets forth a method for providing relevant results for queries. According to some embodiments, the method can be implemented by a server computing device, and includes the steps of (1) receiving a query from a client computing device, (2) providing the query to a first machine learning (ML) model to produce a text answer to the query, where the text answer includes a plurality of text segments, and each text segment of the plurality of text segments is associated with a respective image search query that corresponds to the query and the text segment, (3) for each text segment of the plurality of text segments: providing, to a second ML model, (i) the query, and (ii) the respective image search query, to obtain respective one or more digital assets that correspond to the query and the respective image search query, (4) generating results based on (i) the query, (ii) the text answer, (iii) the plurality of text segments, and (iv) the respective one or more digital assets, and (5) causing the results to be output by way of a user interface on the client computing device.

Other embodiments include a non-transitory computer readable storage medium configured to store instructions that, when executed by a processor included in a computing device, cause the computing device to carry out the various steps of any of the foregoing methods. Further embodiments include a computing device that is configured to carry out the various steps of any of the foregoing methods.

Other aspects and advantages of the embodiments described herein will become apparent from the following detailed description taken in conjunction with the accompanying drawings which illustrate, by way of example, the principles of the described embodiments.

### BRIEF DESCRIPTION OF THE DRAWINGS

The included drawings are for illustrative purposes and serve only to provide examples of possible structures and arrangements for the disclosed inventive apparatuses and methods for providing wireless computing devices. These drawings in no way limit any changes in form and detail that may be made to the embodiments by one skilled in the art without departing from the spirit and scope of the embodiments. The embodiments will be readily understood by the following detailed description in conjunction with the accompanying drawings, wherein like reference numerals designate like structural elements.

FIG. 1A illustrates an application process for interacting with a system.

FIG. 1B illustrates an application process for interacting with a system.

FIG. 1C illustrates software architecture of a device that includes Application Programming Interface (API) calling instructions.

FIG. 1D illustrates software architecture of a system that includes an API and implementation instructions.

FIG. 1E illustrates an application process for interacting with a system using API calling instructions.

FIG. 1F illustrates an application process for interacting with a system using API calling instructions.

FIG. 1G illustrates a block diagram of different components of a system that can be configured to implement the various techniques described herein, according to some embodiments.

FIG. 2A illustrates a conceptual diagram of an example sequence of interactions between various entities described in conjunction with FIG. 1G, to carry out a first approach for providing relevant results for queries, according to some embodiments.

FIG. 2B illustrates a method of a first approach for providing relevant results for queries, according to some embodiments.

FIG. 2C illustrates a conceptual diagram of example user interfaces that can be provided by a client computing device in conjunction with carrying out the steps described in conjunction with FIGS. 2A-2B, according to some embodiments.

FIG. 3A illustrates a conceptual diagram of an example sequence of interactions between various entities described in conjunction with FIG. 1G, to carry out a second approach for providing relevant results for queries, according to some embodiments.

FIG. 3B illustrates a method of a second approach for providing relevant results for queries, according to some embodiments.

FIG. 3C illustrates a conceptual diagram of example user interfaces that can be provided by a client computing device in conjunction with carrying out the steps described in conjunction with FIGS. 3A-3B, according to some embodiments.

FIG. 4 illustrates a detailed view of a computing device that can be used to implement the various components described herein, according to some embodiments.

### DETAILED DESCRIPTION

Representative applications of apparatuses and methods according to the presently described embodiments are provided in this section. These examples are being provided solely to add context and aid in the understanding of the described embodiments. It will thus be apparent to one skilled in the art that the presently described embodiments can be practiced without some or all of these specific details. In other instances, well known process steps have not been described in detail in order to avoid unnecessarily obscuring the presently described embodiments. Other applications are possible, such that the following examples should not be taken as limiting.

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLM s). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly, a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

The described embodiments relate generally to providing relevant results for queries. More particularly, the described embodiments provide techniques for identifying digital assets—such as digital images, animations, videos, etc.—that are relevant to text-based results generated in response to a given query, and then organically incorporating the digital assets into the text-based results.

Implementations and techniques within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, application extensions, widgets, processes, software, software modules and/or components.

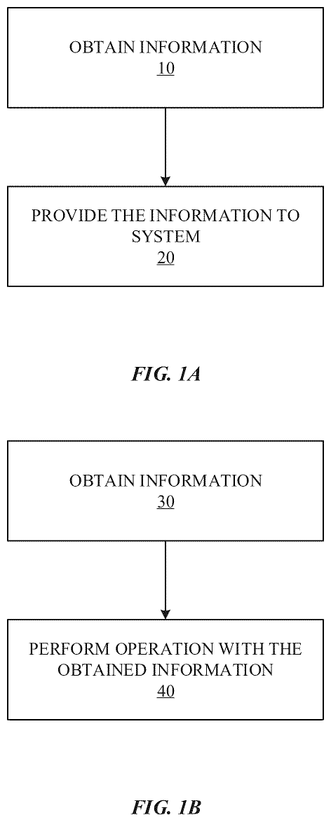

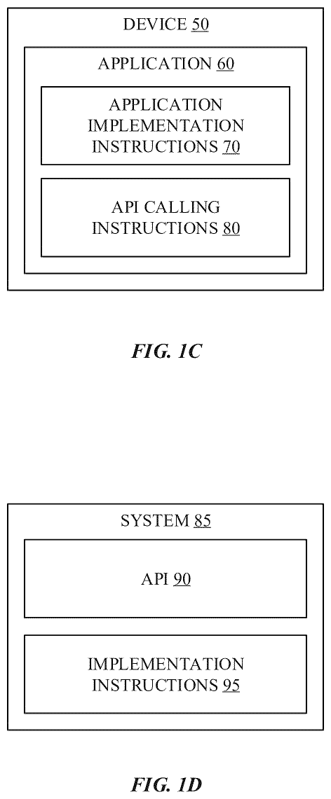

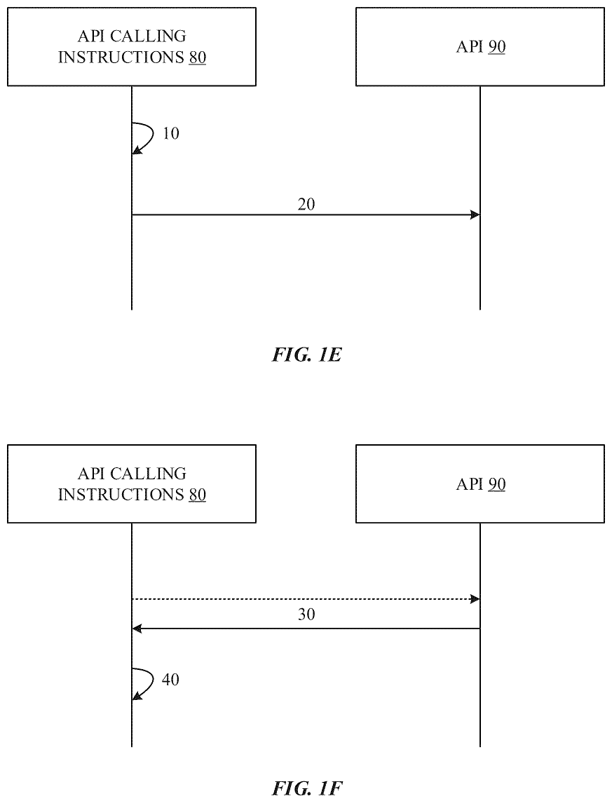

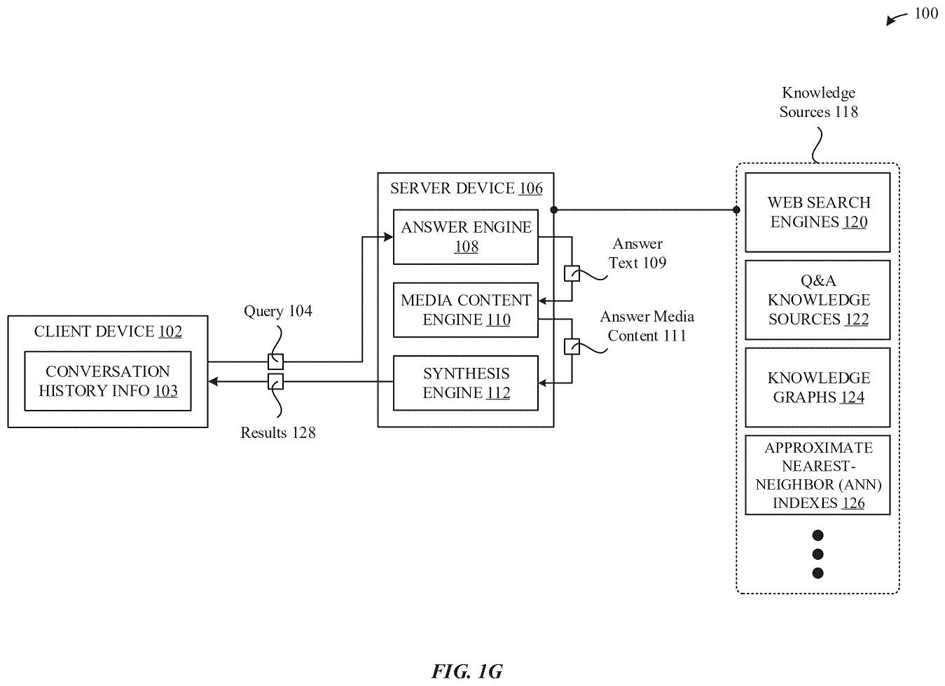

Implementations within the scope of the present disclosure include a computer-readable storage medium that encodes instructions organized as an application (e.g., application 60) that, when executed by one or more processing units, control an electronic device (e.g., device 50) to perform the method of FIG. 1A, the method of FIG. 1B, and/or one or more other processes and/or methods described herein.

It should be recognized that application 60 (shown in FIG. 1C) can be any suitable type of application, including, for example, one or more of: a voice assistant application, a browser application, an application that functions as an execution environment for plug-ins, widgets or other applications, a fitness application, a health application, a digital payments application, a media application, a social network application, a messaging application, a search application, and/or a maps application. In some embodiments, application 60 is an application that is pre-installed on device 50 at purchase (e.g., a first party application). In other embodiments, application 60 is an application that is provided to device 50 via an operating system update file (e.g., a first party application or a second party application). In other embodiments, application 60 is an application that is provided via an application store. In some embodiments, the application store can be an application store that is pre-installed on device 50 at purchase (e.g., a first party application store). In other embodiments, the application store is a third-party application store (e.g., an application store that is provided by another application store, downloaded via a network, and/or read from a storage device).

Referring to FIG. 1A and FIG. 1E, application 60 obtains information (e.g., step 10). In some embodiments, at step 10, information is obtained from at least one hardware component of the device 50. In some embodiments, at step 10, information is obtained from at least one software module (e.g., set of instructions) of the device 50. In some embodiments, at step 10, information is obtained from at least one hardware component external to the device 50 (e.g., a peripheral device, an accessory device, a server, etc.). In some embodiments, the information obtained at step 10 includes audio information, wake word information, positional information, time information, notification information, user information, environment information, electronic device state information, weather information, media information, historical information, event information, hardware information, and/or motion information. In some embodiments, in response to and/or after obtaining the information at step 10, application 60 provides the information to a system (e.g., step 20).

In some embodiments, the system (e.g., 80 shown in FIG. 1D) is an operating system hosted on the device 50. In some embodiments, the system (e.g., 80 shown in FIG. 1D) is an external device (e.g., a server, a peripheral device, an accessory, a personal computing device, etc.) that includes an operating system.

Referring to FIG. 1B and FIG. 1F, application 60 obtains information (e.g., step 30). In some embodiments, the information obtained at step 30 includes audio information, wake word information, positional information, time information, notification information, user information, environment information electronic device state information, weather information, media information, historical information, event information, hardware information and/or motion information. In response to and/or after obtaining the information at step 30, application 60 performs an operation with the information (e.g., step 40). In some embodiments, the operation performed at step 40 includes: providing information to an application based on the information, obtaining data from an application based on the information, providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 85 based on the information.

In some embodiments, one or more steps of the method of FIG. 1A and/or the method of FIG. 1B is performed in response to a trigger. In some embodiments, the trigger includes detection of an event, a notification received from system 85, a user input, and/or a response to a call to an API provided by system 85.

In some embodiments, the instructions of application 60, when executed, control device 50 to perform the method of FIG. 1A and/or the method of FIG. 1B by calling an application programming interface (API) (e.g., API 90) provided by system 85. In some embodiments, application 60 performs at least a portion of the method of FIG. 1A and/or the method of FIG. 1B without calling API 90.

In some embodiments, one or more steps of the method of FIG. 1A and/or the method of FIG. 1B includes calling an API (e.g., API 90) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 1C, device 50 is illustrated. In some embodiments, device 50 is a personal computing device, a smart phone, a smart watch, a fitness tracker, a head mounted display (HMD) device, a media device, a communal device, a speaker, a television, and/or a tablet. As illustrated in FIG. 1C, device 50 includes application 60 and operating system (e.g., system 85 shown in FIG. 1D). Application 60 includes application implementation instructions 70 and API calling instructions 80. System 85 includes API 90 and implementation instructions 95. It should be recognized that device 50, application 60, and/or system 85 can include more, fewer, and/or different components than illustrated in FIGS. 1C and 1D.

In some embodiments, application implementation instructions 70 is a software module that includes a set of one or more computer-executable instructions. In some embodiments, the set of one or more instructions of instructions 70 correspond to one or more operations performed by application 60. For example, when application 60 is a voice assistant application, application implementation instructions 70 can include operations to process a voice assistant request. In another example, when application 60 is a search application, application implementation instructions can include operations to process search requests, which includes generating responses that include digital assets (e.g., digital images, animations, video, audio, etc.) that complement text content. In some embodiments, application implementation instructions 70 communicates with API calling instructions to communicate with system 85 via API 90 (shown in FIG. 1D).

In some embodiments, API-calling instructions 80 is a software module that includes a set of one or more computer-executable instructions.

In some embodiments, implementation instructions 95 is a software module that includes a set of one or more computer-executable instructions.

In some embodiments, API 90 is a software module that includes a set of one or more computer-executable instructions. In some embodiments, API 90 provides an interface that allows a different set of instructions (e.g., API calling instructions 80) to access and/or use one or more functions, methods, procedures, data structures, classes, and/or other services provided by implementation instructions 95 of system 85. For example, API-calling instructions 80 can access a feature of implementation instructions 95 through one or more API calls or invocations (e.g., embodied by a function or a method call) exposed by API 90 and can pass data and/or control information using one or more parameters via the API calls or invocations. In some embodiments, API 90 allows application 60 to use a service provided by a Software Development Kit (SDK) library. In other embodiments, application 60 incorporates a call to a function or method provided by the SDK library and provided by API 90 or uses data types or objects defined in the SDK library and provided by API 90. In some embodiments, API-calling instructions 80 makes an API call via API 90 to access and use a feature of implementation instructions 95 that is specified by API 90. In such embodiments, implementation instructions 95 can return a value via API 90 to API-calling instructions 80 in response to the API call. The value can report to application 60 the capabilities or state of a hardware component of device 50, including those related to aspects such as input capabilities and state, output capabilities and state, processing capability, power state, storage capacity and state, and/or communications capability. In some embodiments, API 90 is implemented in part by firmware, microcode, or other low-level logic that executes in part on the hardware component.

In some embodiments, API 90 allows a developer of API-calling instructions 80 (which can be a third-party developer) to leverage a feature provided by implementation instructions 95. In such embodiments, there can be one or more set of API-calling instructions (e.g., including API-calling instructions 80) that communicate with implementation instructions 95. In some embodiments, API 90 allows multiple sets of API-calling instructions written in different programming languages to communicate with implementation instructions 95 (e.g., API 90 can include features for translating calls and returns between implementation instructions 95 and API-calling instructions 80) while API 90 is implemented in terms of a specific programming language. In some embodiments, API-calling instructions 80 calls APIs from different providers such as a set of APIs from an OS provider, another set of APIs from a plug-in provider, and/or another set of APIs from another provider (e.g., the provider of a software library) or creator of the another set of APIs.

Examples of API 90 can include one or more of: a voice assistant API, a pairing API (e.g., for establishing secure connection, e.g., with an accessory), a device detection API (e.g., for locating nearby devices, e.g., media devices and/or smartphone), a payment API, a UIK it API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, a search API, and/or image processing API. In some embodiments the sensor API is an API for accessing data associated with a sensor of device 50. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation instructions 95 is a system (e.g., operating system, server system) software module (e.g., a collection of computer-readable instructions) that is constructed to perform an operation in response to receiving an API call via API 90. In some embodiments, implementation instructions 95 is constructed to provide an API response (via API 90) as a result of processing an API call. By way of example, implementation instructions 95 and API-calling instructions 80 can each be any one of an operating system, a library, a device driver, an API, an application program, or other module. It should be understood that implementation instructions 95 and API-calling instructions 80 can be the same or different type of software module from each other. In some embodiments, implementation instructions 95 is embodied at least in part in firmware, microcode, or other hardware logic.

In some embodiments, implementation instructions 95 returns a value through API 90 in response to an API call from API-calling instructions 80. While API 90 defines the syntax and result of an API call (e.g., how to invoke the API call and what the API call does), API 90 might not reveal how implementation instructions 95 accomplishes the function specified by the API call. Various API calls are transferred via the one or more application programming interfaces between API-calling instructions 80 and implementation instructions 95. Transferring the API calls can include issuing, initiating, invoking, calling, receiving, returning, and/or responding to the function calls or messages. In other words, transferring can describe actions by either of API-calling instructions 80 or implementation instructions 95. In some embodiments, a function call or other invocation of API 90 sends and/or receives one or more parameters through a parameter list or other structure.

In some embodiments, implementation instructions 95 provides more than one API, each providing a different view of or with different aspects of functionality implemented by implementation instructions 95. For example, one API of implementation instructions 95 can provide a first set of functions and can be exposed to third party developers, and another API of implementation instructions 95 can be hidden (e.g., not exposed) and provide a subset of the first set of functions and also provide another set of functions, such as testing or debugging functions which are not in the first set of functions. In some embodiments, implementation instructions 95 calls one or more other components via an underlying API and thus be both a set of API calling instructions and a set of implementation instructions. It should be recognized that implementation instructions 95 can include additional functions, methods, classes, data structures, and/or other features that are not specified through API 90 and are not available to API calling instructions 80. It should also be recognized that API calling instructions 80 can be on the same system as implementation instructions 95 or can be located remotely and access implementation instructions 95 using API 90 over a network. In some embodiments, implementation instructions 95, API 90, and/or API-calling instructions 80 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

FIG. 1G illustrates a block diagram of different components of a system 100 that can be configured to implement the various techniques described herein, according to some embodiments. As shown in FIG. 1G, the system 100 can include a client computing device 102 and a server computing device 106. It is noted that, in the interest of simplifying this disclosure, the client computing device 102 and the server computing device 106 are discussed in singular capacities. In that regard, it should be appreciated that the system 100 can include any number of client computing devices 102 and server computing devices 106, consistent with the scope of this disclosure.

According to some embodiments, the client computing device 102 can represent any form of computing device operated by an individual, an entity, etc., such as a wearable computing device, a smartphone computing device, a tablet computing device, a laptop computing device, a desktop computing device, a rack mount computing device, a gaming computing device, a smart home computing device, an Internet of Things (IoT) computing device, and so on. According to some embodiments, the server computing device 106 can represent any form of computing device, such as a blade server, a rack server, a tower server, and so on. It is noted that the foregoing examples are not meant to be limiting, and that the client computing device 102/server computing device 106 can represent any type, form, etc., of computing device, consistent with the scope of this disclosure.

As shown in FIG. 1G, and as described in greater detail herein, the client computing device 102 can issue queries 104 to a server computing device 106 (e.g., via the Internet, a network connection, etc.), where, in turn, the server computing device 106 can generate and provide results 128 to the client computing device 102 (e.g., over the aforementioned connections, different connections, etc.). According to some embodiments, and as shown in FIG. 1G, the client computing device 102 can store conversation history information 103, which can include information associated with the queries 104, the results 128, etc., as well as any other type, form, etc., of information, at any level of granularity, pertaining to the interactions between the client computing device 102 and the server computing device 106. According to some embodiments, the conversation history 103 can also represent/store other information associated with a user/the users of the client computing device 102, such as user account information, demographic-related information, device-related information (associated with the client computing device 102), and so on. It is noted that the conversation history 103 can be stored locally on the client computing device 102, the server computing device 106, and/or any other computing devices, which can improve overall efficiency, enable synchronization functionalities, and so on. As described in greater detail herein, the conversation history 103 can be utilized to improve the overall accuracy of the results 128 that are generated and provided by the server computing device 106.

As shown in FIG. 1G, the server computing device 106 can implement an answer engine 108, a media content engine 110, and a synthesis engine 112. According to some embodiments, the answer engine 108, the media content engine 110, and the synthesis engine 112 can implement one or more machine learning (ML)/artificial intelligence (AI) models—such as small language models (SLMs), large language models (LLMs), rule-based models, ranking models, traditional machine learning models, custom models, ensemble models, knowledge graph models, hybrid models, domain-specific models, sparse models, transfer learning models, symbolic artificial intelligence (AI) models, generative adversarial network models, reinforcement learning models, biological models, and so on. It is noted that the foregoing examples are not meant to be limiting, and that any number, type, form, etc., of AI model(s), can be implemented by any of the entities illustrated in FIG. 1G, consistent with the scope of this disclosure.

As a brief aside, it is noted that the answer engine 108, the media content engine 110, the synthesis engine 112, etc., can be configured to interface with the appropriate knowledge sources 118 to enable, supplement, etc., the techniques that they are configured to implement. According to some embodiments, the aforementioned entities can employ any number/type of AI models to effectively identify the appropriate knowledge source(s) 118 with which to engage. Alternatively (or additionally), a given one of the aforementioned entities can assign the appropriate knowledge sources 118 to be utilized by other entities. In this manner, the task of other entities identifying knowledge sources 118 can be reduced or eliminated, which can improve efficiency under certain configurations of the system 100.

According to some embodiments, and as shown in FIG. 1G, the knowledge sources 118 can include, for example, web search engines 120, question and answer (Q&A) knowledge sources 122, knowledge graphs 124, approximate nearest-neighbor (ANN) indexes 126, and so on. It is noted that the knowledge sources 118 illustrated in FIG. 1G and described herein should not be construed as limiting, and that the answer engine 108, media content engine 110, synthesis engine 112, etc., can be configured to access any number, type, form, etc., of knowledge source(s) 118 capable of receiving queries and providing responses, consistent with the scope of this disclosure.

According to some embodiments, the web search engines 120 can represent web search entities that are capable of receiving queries and providing answers based on what is accessible via the Internet. To implement this functionality, the web search engines 120 can “crawl” the Internet, which involves identifying, parsing, and indexing the content of web pages, such that relevant content can be efficiently identified in response to search queries that are received. In this manner, the web search engine 120 can be capable of providing information that is relevant to/useful for processing queries 104 when they are received. For example, when a given web page is relevant to digital images—e.g., a news article that discusses the top twenty places to visit in Paris during summertime-indexing the web page can include identifying each image referenced in the web page, storing each image into a content database, and linking the web page to the images (e.g., by associating unique IDs of the images to a uniform resource locator (URL) of the web page). Indexing the web page can also include, for one or more of the images, extracting relevant text from the web page, generating new text based on the extracted text (and/or other information), etc., where the text provides an explanation of why the image is relevant to the web page. For example, the aforementioned example web page may state that a given image is “A popular coffee shop near the Eiffel Tower”. The text can be associated with the URL/unique ID (of the image) so that they are associated with one another. In this regard, the web search engine 120 can effectively provide digital images that are relevant to queries 104, answer text 109, etc., and that include useful information (such as the web page URL, the relevant text obtained/generated from the web page, and so on). It is noted that the foregoing examples are not meant to be limiting, and that any amount, type, form, etc., of content can be extracted from a given web page, generated based on the web page, etc., at any level of granularity, consistent with the scope of this disclosure. As described herein, the web search engine 120 can also be configured to perform live searches, analyses, etc., of web pages to return relevant information about the web pages.

According to some embodiments, the Q&A knowledge sources 122 can represent systems, databases, etc., that can formulate answers to questions that are commonly received. To implement this functionality, the Q&A knowledge sources 122 typically rely on structured or semi-structured knowledge bases that contain a wide range of information, facts, data, or textual content that is manually curated, generated from text corpora, or collected from various sources, such as books, articles, databases, or the Internet.

According to some embodiments, the knowledge graphs 124 can represent systems, databases, etc., that can be accessed to formulate answers to queries that are received. A given knowledge graph 124 typically constitutes a structured representation of knowledge that captures relationships and connections between entities, concepts, data points, etc. in a way that computing devices are capable of understanding.

According to some embodiments, the ANN indexes 126 can represent systems, databases, etc., that can be accessed to formulate answers to queries that are received. A given ANN index 126 typically constitutes a data structure that is arranged in a manner that enables similarity searches and retrievals in high-dimensional spaces to be efficiently performed. This makes the ANN indexes 126 particularly useful when performing tasks that involve information retrieval, recommendations, and finding similar data points, objects, and so on.

Turning back now to FIG. 1G, according to some embodiments, the answer engine 108, the media content engine 110, and the synthesis engine 112 can be configured to implement a first approach for providing results 128 for a given query 104. In particular, the first approach can involve generating results 128 that include (1) answer text 109, and (2) answer media content 111—e.g., a digital image, a digital video, a digital animation, a digital audio clip, a digital document, etc. that complements the answer text 109. For example, the answer media content 111 can precede, be placed aside, follow, be integrated within, etc., the answer text 109. This approach can be useful to respond to queries 104 where, for example, a single digital asset sufficiently complements the answer text 109, and where the digital asset and the answer text 109 can be simultaneously displayed in a user interface (e.g., a popup user interface, a card-shaped user interface, etc.).

According to some embodiments, the answer engine 108, the media content engine 110, and the synthesis engine 112 can be configured to implement a second approach for providing results 128 for a given query 104. In particular, the second approach can involve generating results 128 that include (1) answer text 109 that is separated into different segments, and (2) respective answer media content 111 that complements each segment and is disposed relative to the segment. This approach can be useful to respond to queries 104 where, for example, the answer includes a breakdown of a particular process, and where the digital assets and answer text can be displayed within and navigated (e.g., by scrolling) through a user interface (e.g., a chat-based interface).

As a brief aside, and according to some embodiments, the answer engine 108 can be configured to implement any number of AI models to determine whether a given query 104 would benefit from being processed in accordance with the techniques described herein (e.g., where results 128 would be enhanced by including digital assets)—as opposed to, for example, alternative techniques that may require fewer resources to carry out, yet provide satisfactory results (e.g., where results 128 would not necessarily be enhanced by including digital assets). In this regard, and according to some embodiments, the answer engine 108 can generate, for a given query 104, a score that represents a likelihood that utilizing the AI-based approaches described herein would be worthwhile. For example, if the query 104 is “What is the temperature outside?”, then the score could be relatively low, given answer text 109 would constitute a sufficient response to the query 104 (without including answer media content 111). In an alternative example, if the query 104 is “How do you tie a bowtie?”, then the score could be relatively high, given answer text 109 would benefit from accompanying answer media content 111 (e.g., step-by-step digital images, animations, videos, etc.). Accordingly, when the score satisfies a predetermined/tunable threshold, the answer engine 108 can be configured to process the query 104 in accordance with the techniques described herein. Conversely, when the score does not satisfy the predetermined/tunable threshold, the answer engine 108 can be configured to process the query 104 in accordance with the aforementioned alternative techniques.

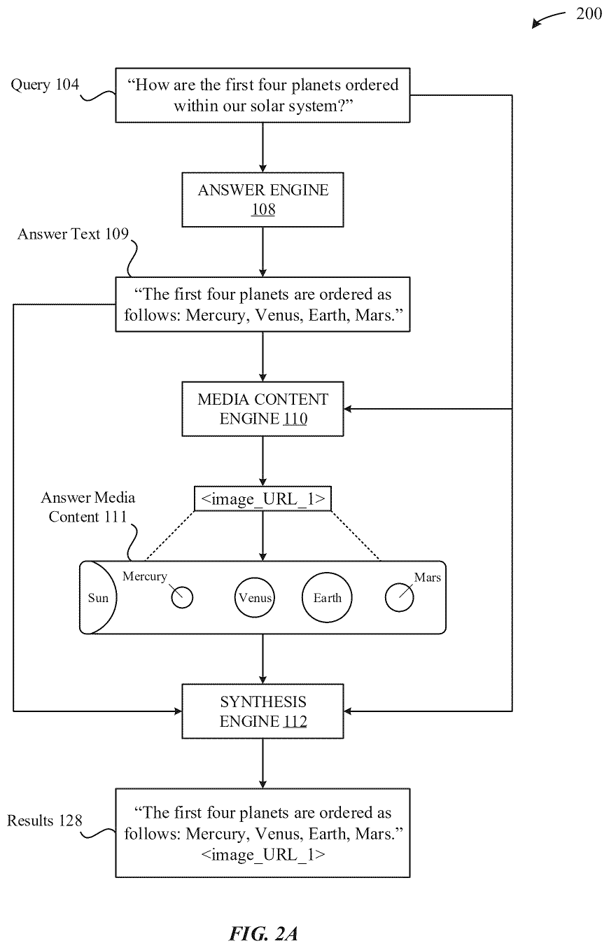

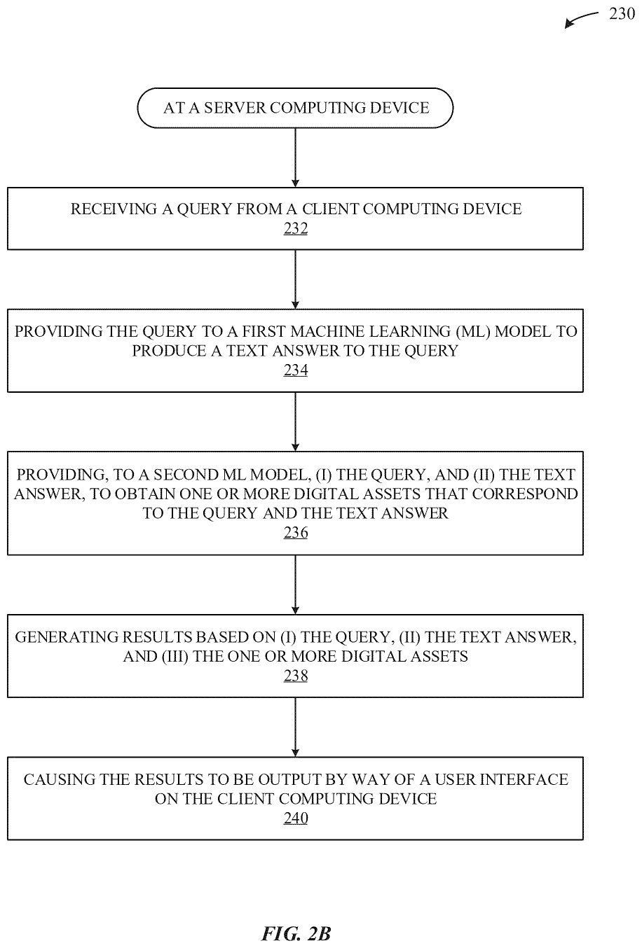

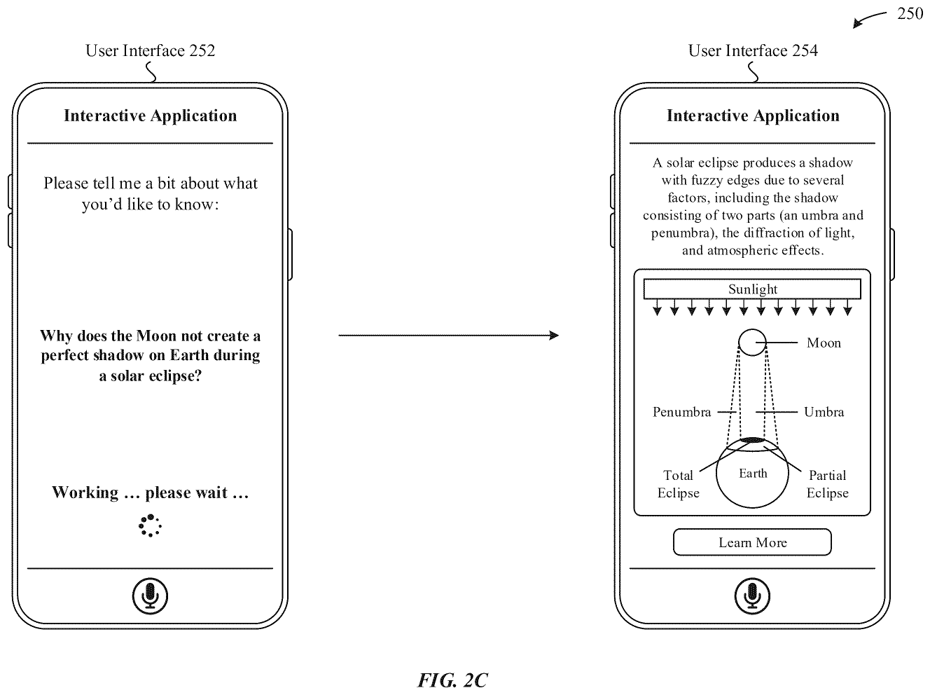

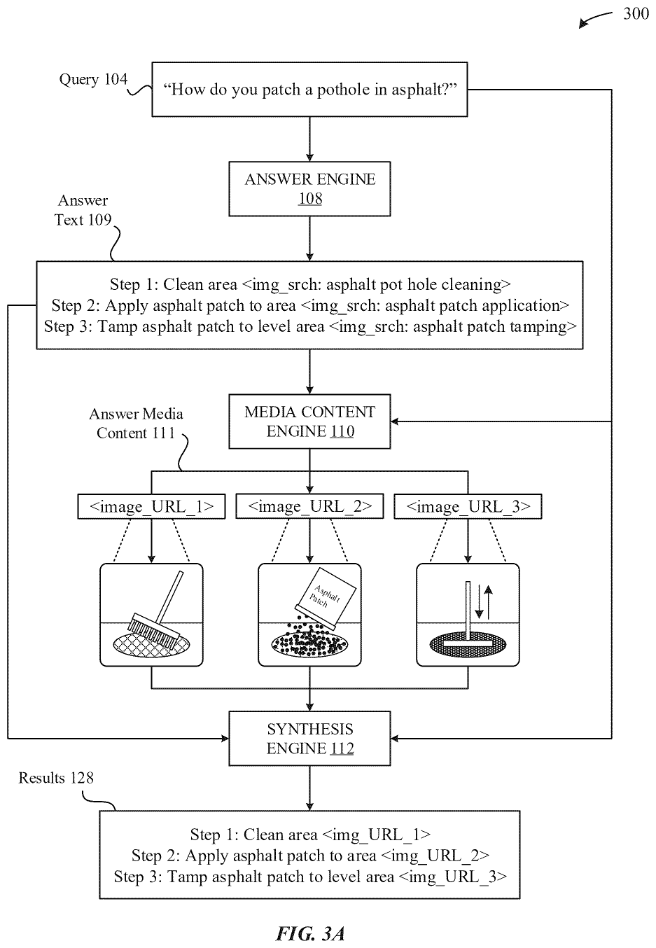

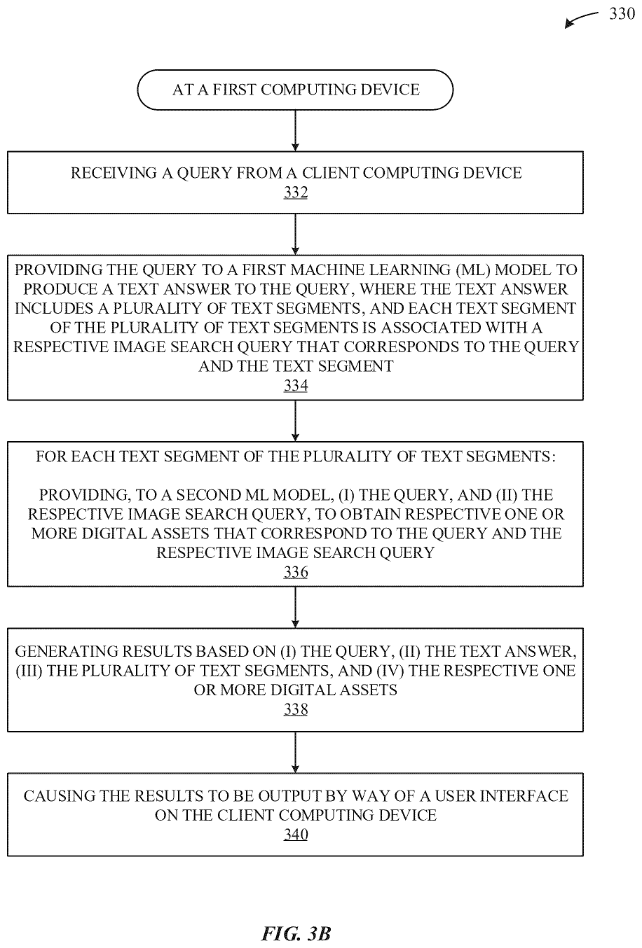

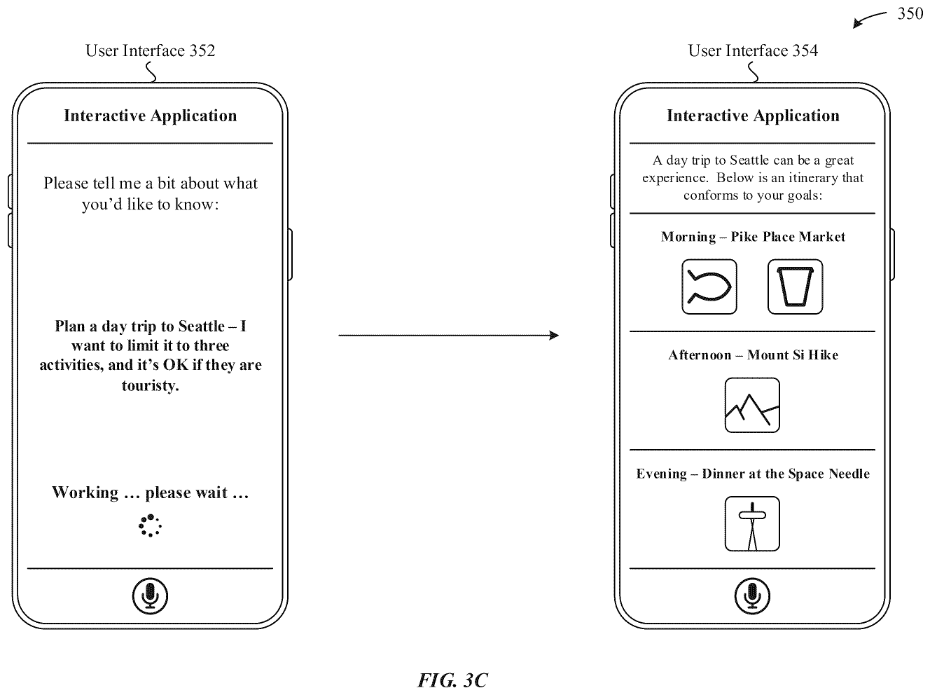

As described in greater detail herein, the answer text 109 (output by the answer engine 108) can include information that enables one or more additional entities—such as the media content engine 110, synthesis engine 112, knowledge sources 118, etc.—to perform respective tasks for supplementing, enhancing, etc., the answer text 109. For example, the answer text 109 can include instructions for tasks to be carried out, such as one or more sub-queries 104 to be processed. In another example, the answer text 109 can include placeholders for which information should be gathered and into which the information should be placed. It is noted that the foregoing examples are not meant to be limiting, and that a more detailed explanation of how the answer text 109 can be generated, configured, etc., is provided below in conjunction with FIGS. 2A-2C and 3A-3C. It is also noted that a given query 104 can include any number of tasks, placeholders, etc., and that any level of nesting can be utilized, consistent with the scope of this disclosure.

According to some embodiments, the media content engine 110 can be configured to obtain digital assets based on a given query 104, answer text 109 generated for the query, other information (e.g., conversation history information 103), and so on. To effectively identify digital assets that are relevant, the media content engine 110 can implement machine learning models that employ techniques that bridge the semantic gap between text and visual content. In one example, the media content engine 110 can implement joint embedding space techniques, where both text and visual data are projected into a common latent space to enable direct comparison of their semantic similarities. In another example, the media content engine 110 can implement cross-modal retrieval techniques, where ML models learn mappings between text and visual modalities, and utilize ranking losses to align these features. In another example, the media content engine 110 can implement visual question answering (VQA) models, which utilize attention mechanisms to focus on relevant image regions based on textual questions to indirectly identify the most pertinent visual assets. It is noted that the foregoing examples are not meant to be limiting, and that the media content engine 110 can be configured to implement any number, type, form, etc., of ML model(s) to identify digital assets that are relevant to the query 104, answer text 109, etc., consistent with the scope of this disclosure. Moreover, it should be appreciated that the ML models can be adapted to identify different types of digital assets (e.g., digital images, digital animations, digital video, digital audio, etc.), consistent with the scope of this disclosure.

According to some embodiments, the media content engine 110 can assign a respective relevance metric to each digital asset that is obtained. In this manner, the media content engine 110 can rank, filter, etc., the digital assets so that the most relevant digital assets are considered for inclusion in the results 128. In some cases, the media content engine 110 may run into situations where the relevancy scores for the digital assets obtained for a query 104, answer text 109, etc., do not satisfy a predetermined threshold. In this regard, the media content engine 110 can implement techniques that enable the generation of digital assets that are relevant to the query 104, answer text 109, etc. For example, the media content engine 110 can implement generative adversarial networks (GANs) that utilize attention mechanisms to refine details and create digital images from text input. Under another approach, the media content engine 110 can implement transformer-based models to generate digital images from text input. Under another approach, the media content engine 110 can generate coherent video sequences from text input. Under yet another approach, the media content engine 110 can synthesize natural-sounding digital audio (e.g., speech) from text. It is noted that the foregoing examples are not meant to be limiting, and that the media content engine 110 can implement any number, type, form, etc., of ML model(s) to effectively generate digital assets that are relevant to text-based inputs, consistent with the scope of this disclosure.

Additionally, and according to some embodiments, the media content engine 110 can be configured to implement an explanation agent. According to some embodiments, the explanation agent can be configured to implement any number, type, form, etc., of AI model(s) to provide explanations, summaries, etc., for a given digital asset. To implement this functionality, the explanation agent can analyze any information—such as the query 104, the answer text 109, the digital asset (e.g., metadata associated with the digital asset, the content of the digital asset, etc.), and the like. In one example, the explanation for a given digital asset can include a breakdown of why the digital asset is relevant, a breakdown of how the digital asset was identified, a breakdown of where the digital asset was located, and so on. It is noted that the foregoing examples are not meant to be limiting, and that the explanation can include any type, form, etc., of information, at any level of granularity, consistent with the scope of this disclosure.

As shown in FIG. 1G, the media content engine 110 outputs, to the synthesis engine 112, the digital assets in the form of answer media content 111. The synthesis engine 112 also receives the query 104, the answer text 109, and any other relevant information. In turn, the synthesis engine 112 generates results 128 based on the query 104, the answer text 109, and the answer media content 111 (i.e., the digital assets output by the media content engine 110). According to some embodiments, the synthesis engine 112 can implement any number, type, form, etc., of AI model(s) to filter redundant, inaccurate, irrelevant, etc., information included in the results 128. The synthesis engine 112 can also be configured to identify and eliminate information considered to be “AI hallucinations,” which refer to the generation of false or distorted perceptions, ideas, or sensations by AI systems. This phenomenon can occur when AI models, such as LLM s, generate outputs that are not based on real data but instead originate from patterns or noise present in their training data or model architecture. Such hallucinations can manifest as incorrect information, fantastical scenarios, nonsensical sentences, or a blend of real and fabricated content.

According to some embodiments, when the synthesis engine 112 generates results 128 for a given query 104, the server computing device 106 can be configured to provide the results 128 to the client computing device 102 (that issued the query 104). The results 128 can be organized using any approach that is feasible for sending the results 128 to the client computing device 102 in a manner that is compatible with/understood by the client computing device 102. In turn the client computing device 102 can display the results 128 using the appropriate applications, user interfaces, etc., to enable a user of the client computing device 102 to interact with the aforementioned assets. A more detailed explanation of how the client computing device 102 can enable its user to interact with the aforementioned assets is provided below in conjunction with FIGS. 2A-2C and 3A-3C.

It is noted that the logical breakdown of the entities illustrated in FIG. 1G—as well as the logical flow of the manner in which such entities communicate—should not be construed as limiting. On the contrary, any of the entities illustrated in FIG. 1G can be separated into additional entities within the system 100, combined together within the system 100, or removed from the system 100, consistent with the scope of this disclosure. Additionally, it should be understood that the various components of the computing devices illustrated in FIG. 1G are presented at a high level in the interest of simplification. For example, although not illustrated in FIG. 1G, it should be appreciated that the various computing devices can include common hardware/software components that enable the above-described software entities to be implemented. For example, each of the computing devices can include one or more processors that, in conjunction with one or more volatile memories (e.g., a dynamic random-access memory (DRAM)) and one or more storage devices (e.g., hard drives, solid-state drives (SSDs), etc.), enable the various software entities described herein to be executed. Moreover, each of the computing devices can include communications components that enable the computing devices to transmit information between one another.

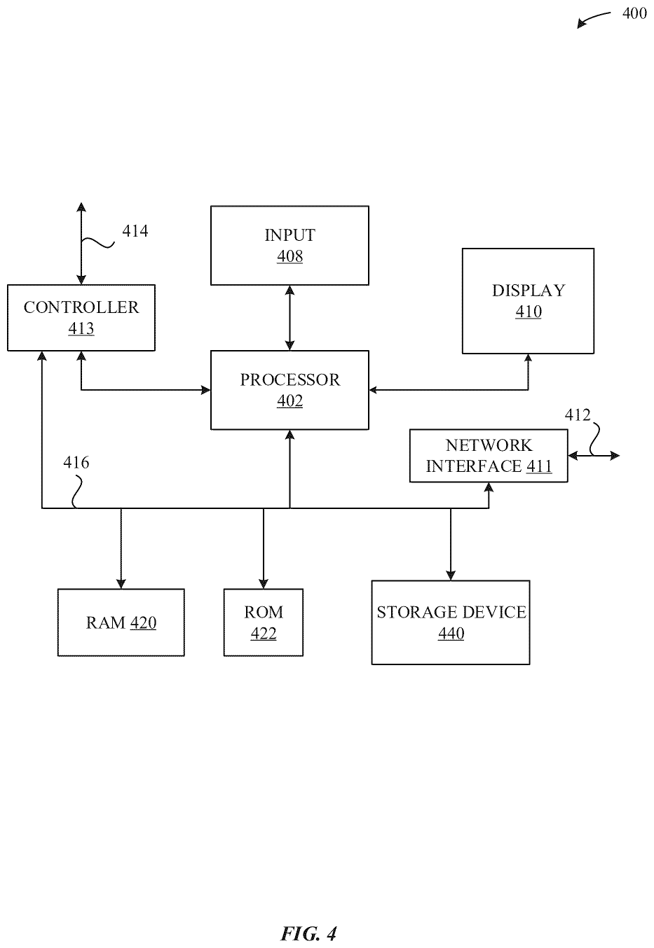

A more detailed explanation of these hardware components is provided below in conjunction with FIG. 4. It should additionally be understood that the computing devices can include additional entities that enable the implementation of the various techniques described herein consistent with the scope of this disclosure. It should additionally be understood that the entities described herein can be combined or split into additional entities consistent with the scope of this disclosure. It should further be understood that the various entities described herein can be implemented using software-based or hardware-based approaches consistent with the scope of this disclosure.

Accordingly, FIG. 1G provides an overview of the manner in which the system 100 can implement the various techniques described herein, according to some embodiments. A more detailed breakdown of the manner in which these techniques can be implemented will now be provided below in conjunction with FIGS. 2A-2C and 3A-3C.

FIG. 2A illustrates a conceptual diagram 200 of an example sequence of interactions between various entities described above in conjunction with FIG. 1G, to carry out a first approach for providing relevant results for queries, according to some embodiments. As shown in FIG. 2A, a query 104—“How are the first four planets ordered within our solar system?”—is received by the server computing device 106. The query 104 can be received, for example, from a user typing the query 104 into a client computing device 102, dictating the query 104 to the client computing device 102, etc. As shown in FIG. 2A, the query 104 is routed to the answer engine 108. As described herein, the answer engine 108 can be configured to determine whether it would be beneficial to include digital assets with results 128 for the query 104. For example, the answer engine 108 can analyze the query 104 itself, answer text 109 that is generated based on the query 104, and so on. In another example, the answer engine 108 can interface with the media content engine 110 to obtain digital assets, and then determine—e.g., based on relevance scores associated with the digital assets—whether to include or omit the digital assets from the results 128.

As shown in FIG. 2A, the answer engine 108 generates answer text 109 based at least in part on the query 104. For example, the answer engine 108 can provide the answer text 109 to one or more LL M s to cause the one or more LL M s to output the answer text 109, which states that “The first four planets are ordered as follows: Mercury, Venus, Earth, Mars.” As described herein, the conversation history information 103 can optionally be utilized by the one or more LLMs as context that guides how the answer engine 108 generates the answer text 109, including the content of the answer text 109, the layout of the answer text 109, the format of the answer text 109, and so on. It is noted that the foregoing examples are not meant to be limiting, and that the answer text 109 can be configured based on any amount, type, form, etc., of information, at any level of granularity, consistent with the scope of this disclosure.

In the example illustrated in FIG. 2A, the answer engine 108 determines that it would be beneficial to accompany the answer text 109 with digital assets, e.g., given the answer text 109 includes an order-based description, given visual guides can be helpful in educating individuals about the solar system, etc. Accordingly, the answer engine 108 provides, to the media content engine 110, (1) the query 104, and (2) the answer text 109. In this manner, the media content engine 110 is in possession of information that enables the media content engine 110 to obtain digital assets that are relevant to the query 104, the answer text 109, etc. Under one example approach, the media content engine 110 can obtain digital assets that are relevant to the answer text 109, and then filter the digital assets to ensure that they are relevant to the query 104. Alternatively, or additionally, the media content engine 110 can obtain digital assets that are relevant to the query 104, and then filter the digital assets to ensure that they are relevant to the answer text 109. It is noted that the foregoing examples are not meant to be limiting, and that the media content engine 110 can analyze any amount, type, form, etc., of information, at any level of granularity, to effectively determine whether a given digital asset is relevant to the query 104, the answer text 109, etc., consistent with the scope of this disclosure.

As shown in FIG. 2A, the media content engine 110 outputs answer media content 111—which, as shown in FIG. 2A, constitutes a digital image that depicts the sun, as well as an ordered representation of the first four planets of our solar system. The media content engine 110 can obtain the digital image in accordance with the techniques described herein, which can include, for example, obtaining the digital image from a library of digital images, obtaining the digital image from the Internet, generating the digital image (based on the query 104, the answer text 109, etc.), or the like. As shown in FIG. 2A, the media content engine 110 can be configured to output a uniform resource locator (URL) of the digital image, or can output the digital image itself, depending on a configuration of the system 100. In the example illustrated in FIG. 2A, the media content engine 110 outputs the URL of the image (“<image_URL_1>”).

As shown in FIG. 2A, the query 104, the answer text 109, and the answer media content 111 can be output to the synthesis engine 112. In turn, the synthesis engine 112 can generate results 128 that include the answer text 109 and the answer media content 111. The results 128 can optionally include other information, such as a rewrite, restatement, etc., of the query 104. The results 128 can then be provided to the client computing device 102 (that issued the query 104). In turn, the client computing device 102 can display the results 128 by way of a user interface associated with the client computing device 102. Displaying the results 128 can include replacing <image_URL_1> with the image itself, such that the digital image is displayed along with the answer text 109.

FIG. 2B illustrates a method 230 of a first approach for providing relevant results for queries, according to some embodiments. As shown in FIG. 2B, the method 230 begins at step 232, where the server computing device 106 receives a query from a client computing device (e.g., as described above in conjunction with FIGS. 1G and 2A).

At step 234, the server computing device 106 provides the query to a first machine learning (ML) model to produce a text answer to the query (e.g., as described above in conjunction with FIGS. 1G and 2A). At step 236, the server computing device 106 provides, to a second ML model, (i) the query, and (ii) the text answer, to obtain one or more digital assets that correspond to the query and the text answer (e.g., as described above in conjunction with FIGS. 1G and 2A).

At step 238, the server computing device 106 generates results based on (i) the query, (ii) the text answer, and (iii) the one or more digital assets (e.g., as described above in conjunction with FIGS. 1G and 2A). At step 240, the server computing device 106 causes the results to be output by way of a user interface on the client computing device (e.g., as described above in conjunction with FIGS. 1G and 2A).

FIG. 2C illustrates a conceptual diagram 250 of example user interfaces that can be provided by a client computing device 102 in conjunction with carrying out the steps described in conjunction with FIGS. 2A-2B, according to some embodiments. As shown in FIG. 2C, a user interface 252 can be displayed for an interactive application that is being utilized on the client computing device 102 (e.g., an installed application, a web-based application, etc.). In the example illustrated in FIG. 2C, a user of the client computing device 102 provides the query 104 “Why does the Moon not create a perfect shadow on Earth during a solar eclipse?”. In response to receiving the query 104, the client computing device 102 transmits the query 104 to the server computing device 106, and the user interface 252 indicates that the query 104 is being processed. In turn, the server computing device 106 processes the query 104 (e.g., in accordance with the techniques described above in conjunction with FIGS. 1G and 2A-2B), and provides results 128 to the client computing device 102.

As shown in FIG. 2C, the client computing device 102 displays a user interface 254 in response to receiving the results 128. In the example illustrated in FIG. 2C, the results 128 include answer text 109 that reads “A solar eclipse produces a shadow with fuzzy edges due to several factors, including the shadow consisting of two parts (an umbra and penumbra), the diffraction of light, and atmospheric effects.” The results 128 also include answer media content 111—e.g., a digital image that is relevant to the query 104, the answer text 109, etc. Additionally, and as shown in FIG. 2C, the results 128 include a “Learn More” option that, when selected, can cause the client computing device 102 to provide additional information. For example, the “Learn More” option can be linked to the URL of a web page from which the digital image was extracted, to the URL of a web page that is most relevant to the query 104, answer text 109, etc. In another example, the “Learn More” option can be linked to additional digital assets that were determined to be relevant to the query 104, answer text 109, etc., but were not configured to be (initially) displayed within the results 128. For example, the “Learn More” option can load animations, videos, etc., that are relevant to the ordering of planets within the solar system. It is noted that the user interfaces illustrated in FIG. 2C are not meant to be limiting, and that the user interfaces can be configured to include any amount, type, form, etc., of information, UI elements, etc., at any level of granularity, consistent with the scope of this disclosure.

FIG. 3A illustrates a conceptual diagram 300 of an example sequence of interactions between various entities described above in conjunction with FIG. 1G, to carry out a second approach for providing relevant results for queries, according to some embodiments. As shown in FIG. 3A, a query 104—“How do you patch a pothole in asphalt?”—is received by the server computing device 106. The query 104 can be received, for example, from a user typing the query 104 into a client computing device 102, dictating the query 104 to the client computing device 102, etc. As shown in FIG. 3A, the query 104 is routed to the answer engine 108. As described herein, the answer engine 108 can be configured to determine whether it would be beneficial to include digital assets with results 128 for the query 104. For example, the answer engine 108 can analyze the query 104 itself, answer text 109 that is generated based on the query 104, and so on. In another example, the answer engine 108 can interface with the media content engine 110 to obtain digital assets, and then determine e.g., based on relevance scores associated with the digital assets-whether to include or omit the digital assets from the results 128.

As shown in FIG. 3A, the answer engine 108 generates answer text 109 based at least in part on the query 104. For example, the answer engine 108 can provide the answer text 109 to one or more LLM s to cause the one or more LLM s to output the answer text 109, which includes various steps to be carried out to effectively patch a pothole in asphalt. As shown in FIG. 3A, each step—also referred to herein as a text segment—can be accompanied by (1) an indication of a particular task to be carried out, and (2) information that is relevant to the task. In the example illustrated in FIG. 3A, the indication of the particular task is denoted as “img_srch”, which conveys that a search for a digital image should be performed. Moreover, the information that is relevant to the task constitutes an image search query, i.e., text-based information that is relevant to the text segment. According to some embodiments, a given image search query is generated based on the corresponding text segment, the answer text 109, the query 104, other information, or some combination thereof.

As described herein, the answer engine 108 provides, to the media content engine 110, (1) the query 104, and (2) the answer text 109. In this manner, the media content engine 110 is in possession of information that enables the media content engine 110 to obtain digital assets that are relevant to the query 104, the answer text 109, etc. As shown in FIG. 3A, the media content engine 110 outputs answer media content 111 for each of the tasks included in the answer text 109. In particular, the media content engine 110 outputs a first digital image (“<image_URL_1>”), a second digital image (“<image_URL_2>”), and a third digital image (“<image_URL_3>”), where each of the digital images is relevant to its respective image search query, text segment, etc. again, the media content engine 110 can obtain the digital images in accordance with the techniques described herein, which can include, for example, obtaining the digital images from a library of digital images, obtaining the digital images from the Internet, generating the digital images, or the like. As shown in FIG. 3A, the media content engine 110 can be configured to output uniform resource locators (URLs) for the digital images, or can output the digital images themselves, depending on a configuration of the system 100. In the example illustrated in FIG. 3A, the media content engine 110 outputs the URLs of the image.

As shown in FIG. 3A, the query 104, the answer text 109, and the answer media content 111 can be output to the synthesis engine 112. In turn, the synthesis engine 112 can generate results 128 that include the answer text 109 and the answer media content 111. The results 128 can optionally include other information, such as a rewrite, restatement, etc., of the query 104. The results 128 can then be provided to the client computing device 102 (that issued the query 104). In turn, the client computing device 102 can display the results 128 by way of a user interface associated with the client computing device 102. Displaying the results 128 can include replacing <image_URL_1>, <image_URL_2>, and <image_URL_3> with the corresponding digital images, such that the digital images are displayed along with the answer text 109.

FIG. 3B illustrates a method 330 of a second approach for providing relevant results for queries, according to some embodiments. As shown in FIG. 3, the method 330 begins at step 332, where the server computing device 106 receives a query from a client computing device (e.g., as described above in conjunction with FIGS. 1G, 2A-2C, and 3A). At step 334, the server computing device 106 provides the query to a first machine learning (ML) model to produce a text answer to the query, where the text answer includes a plurality of text segments, and each text segment of the plurality of text segments is associated with a respective image search query that corresponds to the query and the text segment (e.g., as described above in conjunction with FIGS. 1G and 3A).

At step 336, the server computing device 106 performs the following for each text segment of the plurality of text segments: providing, to a second ML model, (i) the query, and (ii) the respective image search query, to obtain respective one or more digital assets that correspond to the query and the respective image search query (e.g., as described above in conjunction with FIGS. 1G and 3A).

At step 338, the server computing device 106 generates results based on (i) the query, (ii) the text answer, (iii) the plurality of text segments, and (iv) the respective one or more digital assets (e.g., as described above in conjunction with FIGS. 1G and 3A). At step 340, the server computing device 106 causes the results to be output by way of a user interface on the client computing device (e.g., as described above in conjunction with FIGS. 1G, 2A-2C, and 3A).

FIG. 3C illustrates a conceptual diagram 350 of example user interfaces that can be provided by a client computing device 102 in conjunction with carrying out the steps described in conjunction with FIGS. 3A-3B, according to some embodiments. As shown in FIG. 3C, a user interface 352 can be displayed for an interactive application that is being utilized on the client computing device 102 (e.g., an installed application, a web-based application, etc.). In the example illustrated in FIG. 3C, a user of the client computing device 102 provides the query 104 “Plan a day trip to Seattle—I want to limit it to three activities, and it's OK if they are touristy.” In response to receiving the query 104, the client computing device 102 transmits the query 104 to the server computing device 106, and the user interface 352 indicates that the query 104 is being processed. In turn, the server computing device 106 processes the query 104 (e.g., in accordance with the techniques described above in conjunction with FIGS. 1G and 3A-3B), and provides results 128 to the client computing device 102.

As shown in FIG. 3C, the client computing device 102 displays a user interface 354 in response to receiving the results 128. In the example illustrated in FIG. 3C, the results 128 include answer text 109 that reads “A day trip to Seattle can be a great experience. Below is an itinerary that conforms to your goals”. The results 128 also include three text segments that break down respective activities for the day trip, where each text segment includes respective answer media content 111—e.g., one or more digital images—that is/are relevant to the text segment, the answer text 109, the query 104, etc. It is noted that the user interfaces illustrated in FIG. 3C are not meant to be limiting, and that the user interfaces can be configured to include any amount, type, form, etc., of information, UI elements, etc., at any level of granularity, consistent with the scope of this disclosure.

FIG. 4 illustrates a detailed view of a computing device 400 that can be used to implement the various components described herein, according to some embodiments. In particular, the detailed view illustrates various components that can be included in the computing devices described above in conjunction with FIG. 1.

As shown in FIG. 4, the computing device 400 can include a processor 402 that represents a microprocessor or controller for controlling the overall operation of computing device 400. The computing device 400 can also include a user input device 408 that allows a user of the computing device 400 to interact with the computing device 400. For example, the user input device 408 can take a variety of forms, such as a button, keypad, dial, touch screen, audio input interface, visual/image capture input interface, input in the form of sensor data, etc. Furthermore, the computing device 400 can include a display 410 (screen display) that can be controlled by the processor 402 to display information to the user. A data bus 416 can facilitate data transfer between at least a storage device 440, the processor 402, and a controller 413. The controller 413 can be used to interface with and control different equipment through an equipment control bus 414. The computing device 400 can also include a network/bus interface 411 that couples to a data link 412. In the case of a wireless connection, the network/bus interface 411 can include a wireless transceiver.

The computing device 400 also includes a storage device 440, which can comprise a single disk or a plurality of disks (e.g., SSDs), and includes a storage management module that manages one or more partitions within the storage device 440. In some embodiments, storage device 440 can include flash memory, semiconductor (solid state) memory or the like. The computing device 400 can also include a Random-Access Memory (RAM) 420 and a Read-Only Memory (ROM) 422. The ROM 422 can store programs, utilities, or processes to be executed in a non-volatile manner. The RAM 420 can provide volatile data storage, and stores instructions related to the operation of the computing devices described herein.

The various aspects, embodiments, implementations, or features of the described embodiments can be used separately or in any combination. Various aspects of the described embodiments can be implemented by software, hardware or a combination of hardware and software. The described embodiments can also be embodied as computer readable code on a computer readable medium. The computer readable medium is any data storage device that can store data that can be read by a computer system. Examples of the computer readable medium include read-only memory, random-access memory, CD-ROM s, DVDs, magnetic tape, hard disk drives, solid state drives, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

As described herein, one aspect of the present technology is the gathering and use of data available from various sources to improve user experiences. The present disclosure contemplates that in some instances, this gathered data may include personal information data that uniquely identifies or can be used to contact or locate a specific person. Such personal information data can include demographics data, location-based data, telephone numbers, email addresses, home addresses, data or records relating to a user's health or level of fitness (e.g., vital signs measurements, medication information, exercise information), date of birth, smart home activity, or any other identifying or personal information. The present disclosure recognizes that the use of such personal information data, in the present technology, can be used to the benefit of users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select to provide only certain types of data that contribute to the techniques described herein. In addition to providing “opt in” and “opt out” options, the present disclosure contemplates providing notifications relating to the access or use of personal information. For instance, a user may be notified that their personal information data may be accessed and then reminded again just before personal information data is accessed.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference May be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

What is claimed is:

1. A method for providing relevant results for queries, the method comprising, by a server computing device:
receiving a query from a client computing device;
providing the query to a first machine learning (ML) model to produce a text answer to the query;
providing, to a second ML model, (i) the query, and (ii) the text answer, to obtain one or more digital assets that correspond to the query and the text answer;
generating results based on (i) the query, (ii) the text answer, and (iii) the one or more digital assets; and
causing the results to be output by way of a user interface on the client computing device.

2. The method of claim 1, further comprising, prior to providing the query and the text answer to the second ML model:
generating a digital asset benefit metric based on the query and the text answer; and
determining that the digital asset benefit metric satisfies a threshold.

3. The method of claim 2, wherein the digital asset benefit metric represents an overall helpfulness associated with accompanying the text answer with at least one digital asset.

4. The method of claim 1, wherein each digital asset of the one or more digital assets:
preexists and is obtained from a data store, or is generated based on the query, the text answer, or some combination thereof; and
is assigned a respective digital asset relevance metric that represents a correlation strength between the digital asset, the query, and the text answer, wherein the digital asset relevance metric satisfies a threshold.

5. The method of claim 4, wherein generating the results further comprises:
ordering the one or more digital assets based on their respective digital asset relevance metrics.

6. The method of claim 4, wherein, for a given digital asset obtained from the data store, the respective digital asset relevance metric is calculated based on at least one label, at least one tag, at least one annotation, at least one description, at least one feature vector, at least one embedding, metadata information, or some combination thereof, associated with the given digital asset.

7. The method of claim 1, wherein each digital asset of the one or more digital assets comprises a digital image, a digital video, a digital animation, a digital audio clip, a digital document, or some combination thereof.

8. A non-transitory computer readable storage medium configured to store instructions that, when executed by at least one processor included in a computing device, cause the computing device to provide relevant results for queries, by carrying out steps that include:
receiving a query from a client computing device;
providing the query to a first machine learning (ML) model to produce a text answer to the query;
providing, to a second ML model, (i) the query, and (ii) the text answer, to obtain one or more digital assets that correspond to the query and the text answer;
generating results based on (i) the query, (ii) the text answer, and (iii) the one or more digital assets; and
causing the results to be output by way of a user interface on the client computing device.

9. The non-transitory computer readable storage medium of claim 8, wherein the steps further include, prior to providing the query and the text answer to the second ML model:
generating a digital asset benefit metric based on the query and the text answer; and
determining that the digital asset benefit metric satisfies a threshold.

10. The non-transitory computer readable storage medium of claim 9, wherein the digital asset benefit metric represents an overall helpfulness associated with accompanying the text answer with at least one digital asset.

11. The non-transitory computer readable storage medium of claim 8, wherein each digital asset of the one or more digital assets:
preexists and is obtained from a data store, or is generated based on the query, the text answer, or some combination thereof; and
is assigned a respective digital asset relevance metric that represents a correlation strength between the digital asset, the query, and the text answer, wherein the digital asset relevance metric satisfies a threshold.

12. The non-transitory computer readable storage medium of claim 11, wherein generating the results further comprises:
ordering the one or more digital assets based on their respective digital asset relevance metrics.

13. The non-transitory computer readable storage medium of claim 11, wherein, for a given digital asset obtained from the data store, the respective digital asset relevance metric is calculated based on at least one label, at least one tag, at least one annotation, at least one description, at least one feature vector, at least one embedding, metadata information, or some combination thereof, associated with the given digital asset.

14. The non-transitory computer readable storage medium of claim 8, wherein each digital asset of the one or more digital assets comprises a digital image, a digital video, a digital animation, a digital audio clip, a digital document, or some combination thereof.

15. A method for providing relevant results for queries, the method comprising, by a server computing device:
receiving a query from a client computing device;
providing the query to a first machine learning (ML) model to produce a text answer to the query, wherein the text answer includes a plurality of text segments, and each text segment of the plurality of text segments is associated with a respective image search query that corresponds to the query and the text segment;
for each text segment of the plurality of text segments:
providing, to a second ML model, (i) the query, and (ii) the respective image search query, to obtain respective one or more digital assets that correspond to the query and the respective image search query;
generating results based on (i) the query, (ii) the text answer, (iii) the plurality of text segments, and (iv) the respective one or more digital assets; and
causing the results to be output by way of a user interface on the client computing device.

16. The method of claim 15, further comprising, prior to providing the query and the respective image search queries to the second ML model:
generating a digital asset benefit metric based on the query and the text answer; and
determining that the digital asset benefit metric satisfies a threshold.

17. The method of claim 16, wherein the digital asset benefit metric represents an overall helpfulness associated with accompanying the text answer with at least one digital asset.

18. The method of claim 15, wherein, for a given text segment of the plurality of text segments, each digital asset of the respective one or more digital assets:
preexists and is obtained from a data store, or is generated based on the query, the respective image search query, or some combination thereof; and
is assigned a respective digital asset relevance metric that represents a correlation strength between the digital asset, the query, and the respective image search query, wherein the digital asset relevance metric satisfies a threshold.

19. The method of claim 18, wherein generating the results further comprises, for each text segment of the plurality of text segments:
ordering the respective one or more digital assets based on their respective digital asset relevance metrics.

20. The method of claim 18, wherein, for a given digital asset obtained from the data store, the respective digital asset relevance metric is calculated based on at least one label, at least one tag, at least one annotation, at least one description, at least one feature vector, at least one embedding, metadata information, or some combination thereof, associated with the given digital asset.

21. The method of claim 15, wherein, for a given text segment of the plurality of text segments, each digital asset of the respective one or more digital assets comprises a digital image, a digital video, a digital animation, a digital audio clip, a digital document, or some combination thereof.
